(19) United States
(12) Patent Application Publication
(10) Pub. No.: US 2018/0135569 A1
(43) Pub. Date: May 17, 2018

(54) ENGINE SYSTEM FOR REMOVING CONDENSED WATER

(71) Applicants: HYUNDAI MOTOR COMPANY, Seoul (KR); KIA MOTORS CORPORATION, Seoul (KR)

(72) Inventors: Dong Hee Han, Seoul (KR); Jong ll Park, Seoul (KR); Seungwoo Hong, Seoul (KR); Hyungbok Lee, Seongnam-si (KR); Joowon Lee, Gwangju-si (KR); Dong Ho Chu, Ansan-si (KR); Hyun Jun Lim, Incheon (KR)

(73) Assignees: HYUNDAI MOTOR COMPANY, Seoul (KR); KIA MOTORS CORPORATION, Seoul (KR)

(21) Appl. No.: 15/672,050

(22) Filed: Aug. 8, 2017

(30) Foreign Application Priority Data
Nov. 11, 2016 (KR) 10-2016-0150479

(51) Int. Cl. F02M 26/46

(52) U.S. Cl. CPC F02M 26/46; F02M 26/06

(57) ABSTRACT

An engine system for removing condensed water may comprise an engine including a plurality of combustion chambers generating driving torque by combustion of fuel; an intake line, in which fresh air flows into the combustion chambers; an exhaust line, in which exhaust gas flows, having been exhausted from the combustion chambers; and an intercooler for cooling compressed air by a compressor of a turbocharger, the intercooler having a coolant circulation line in which coolant flows for cooling the engine.

### CROSS-REFERENCE TO RELATED APPLICATION

This application claims priority to and the benefit of Korean Patent Application No. 10-2016-0150479 filed in the Korean Intellectual Property Office on Nov. 11, 2016, the entire contents of which are incorporated herein by reference.

### BACKGROUND

### (a) Field of the Disclosure

The present disclosure relates to an engine system for removing condensed water. More particularly, the present disclosure relates to an engine system for removing condensed water that is generated in an intercooler.

### (b) Description of the Related Art

An engine appropriately mixes air and fuel and generates driving power by burning the fuel/air mixture.

In order to obtain required output power and combustion efficiency, sufficient air should be supplied to the engine. For this, a turbocharger is used to increase combustion efficiency and to supply sufficient air to the engine.

Generally, a turbine of the turbocharger is rotated by pressure of exhaust gas that is exhausted from the engine. A compressor of the turbocharger compresses fresh air flowing in from the outside and the compressed air is supplied to a combustion chamber of the engine. Turbochargers have been applied to most diesel engines, and have more recently been applied to gasoline engines.

Further, NOx (nitrous oxide) included in the exhaust gas is regulated as a major air pollutant. Research has been carried out in order to determine ways to reduce the amount of NOx in exhaust gases.

An exhaust gas recirculation (EGR) system mounted in a vehicle reduces noxious exhaust gases of the vehicle. Generally, the amount of NOx in the exhaust gas is increased in an oxygen rich air mixture, and the air mixture is combusted satisfactorily well. Therefore, the EGR system reduces the amount of NOx in the exhaust gas as a consequence of a part (e.g., 5-20%) of the exhaust gas being recirculated to the air mixture in order to reduce the oxygen ratio in the air mixture and to hinder combustion.

An LP-EGR (low pressure EGR) system is one of the EGR systems. The LP-EGR system recirculates the exhaust gas passing through the turbine of the turbocharger to an intake path of an upstream side of the compressor.

However, the exhaust gas recirculated by the EGR system has high temperature and humidity. Therefore, condensed water is generated when the recirculated exhaust gas and the external air having a low temperature are mixed.

Particularly, very cold external air (e.g., minus 20 to minus 40° C., minus 4 to minus 40° F.) flows into the engine when an external temperature is low as in the event of a winter season. Further, the recirculated exhaust gas has a high temperature (e.g., 100 to 150° C., 212 to 302° F.) and high humidity (e.g., 15%).

The condensed water is generated at an intercooler disposed in an intake line when the external air and the exhaust gas are mixed.

As such, the condensed water generated at the intercooler flows into a combustion chamber of an engine. There are problems including that combustion becomes unstable and parts of the engine are corroded.

The above information disclosed in this Background section is only to enhance understanding of the background of the disclosure. Therefore, the Background section may contain information that does not form the prior art that is already known in this country to a person of ordinary skill in the art.

### SUMMARY

The present disclosure has been made in an effort to provide an engine system for removing condensed water generated at an intercooler.

An engine system for removing condensed water according to an embodiment of the present disclosure may include an engine having a plurality of combustion chambers generating driving torque by combustion of fuel. The engine system may also include an intake line in which fresh air flows into the combustion chambers. The engine system may further include an exhaust line in which exhaust gas flows, having been exhausted from the combustion chambers. The engine system may also include an in intercooler for cooling compressed air by a compressor of a turbocharger, the intercooler having a coolant circulation line in which coolant cooling the engine flows.

The engine system may further include a cooling line in which the coolant cooling the engine flows, wherein the coolant circulation line disposed in the intercooler is branched from one side of the cooling line and joined to another side of the cooling line.

The coolant circulation line may be disposed at a lower portion of the intercooler.

The engine system may further include a flow amount adjusting valve disposed in the coolant circulation line and adjusting a coolant amount circulating in the intercooler.

The engine system may further include a temperature sensor detecting an external temperature of a vehicle and a controller controlling opening of the flow amount adjusting valve according to the external temperature detected by the temperature sensor.

The controller may close the flow amount adjusting valve when the external temperature is higher than a predetermined temperature.

The controller may open the flow amount adjusting valve when the external temperature is less than a predetermined temperature.

The engine system may further include an exhaust gas recirculation (EGR) apparatus including an EGR line branched from the exhaust line and joined to the intake line and an EGR valve disposed in the EGR line. The engine system may also include a driving information detector detecting a driving information including a water vapor amount included in recirculation gas, a water vapor amount included in fresh air inflowing through the intake line, and a temperature of the recirculation gas and the fresh air. The engine system may further include a controller controlling opening of the EGR valve based on the driving information detected by the driving information detector.

The controller may calculate a maximum EGR ratio at which condensed water is not generated from saturation vapor pressure determined by the water vapor amount included in the recirculation gas, the water vapor amount included in the fresh air, and the temperature of the mixed gas supplied to the intercooler. The controller may adjust the opening of the EGR valve based on the calculated maximum EGR ratio.

The intercooler may be a water cooling type intercooler.

The intercooler may be an air cooling type intercooler.

According to an embodiment of the present disclosure, it is possible to remove condensed water generated in an intercooler by circulating hot coolant in the intercooler.

Further, according to an embodiment of the present disclosure, condensed water is not supplied to a combustion chamber of an engine. As a result, it is possible to obtain combustion stability of the engine and to inhibit or prevent parts of the engine being corroded.

### BRIEF DESCRIPTION OF THE DRAWINGS

The drawings are provided for reference in describing embodiments of the present disclosure, and the spirit of the present disclosure should not be construed only by the accompanying drawings.

FIG. 1 is a schematic view illustrating an engine system for removing condensed water according to an embodiment of the present disclosure.

FIG. 2 is a schematic view illustrating an engine system for removing condensed water according to another embodiment of the present disclosure.

FIG. 3 is a block diagram illustrating an engine system for removing condensed water according to an embodiment of the present disclosure.

The following reference symbols and descriptions are utilized throughout the drawings.
10: intake line
20: engine
21: combustion chamber
23: engine block
25: cooling line
29: main radiator
30: exhaust line
40: exhaust gas purification apparatus
50: exhaust gas recirculation apparatus
51: EGR line
53: EGR cooler
55: EGR valve
60: turbocharger
61: turbine
63: compressor
70: intercooler
75: coolant circulation line
77: flow amount adjusting valve
79: intercooler cooling line
80: driving information detector
90: controller

### DETAILED DESCRIPTION OF THE EMBODIMENTS

The present disclosure is described more fully hereinafter with reference to the accompanying drawings, in which embodiments of the disclosure are shown. As those having ordinary skill in the art would realize, the described embodiments may be modified in various different ways, all without departing from the spirit or scope of the present disclosure.

In order to clearly describe the present disclosure, portions that are not connected with the description will be omitted. Like reference numerals designate like elements throughout the specification and drawings.

In addition, the size and thickness of each configuration shown in the drawings are arbitrarily shown for better understanding and ease of description, but the present disclosure is not limited thereto. In the drawings, the thickness of layers, films, panels, regions, and the like may be exaggerated for clarity.

Hereinafter, an engine system for removing condensed water according to an embodiment of the present disclosure will be described in detail with reference to accompanying drawings.

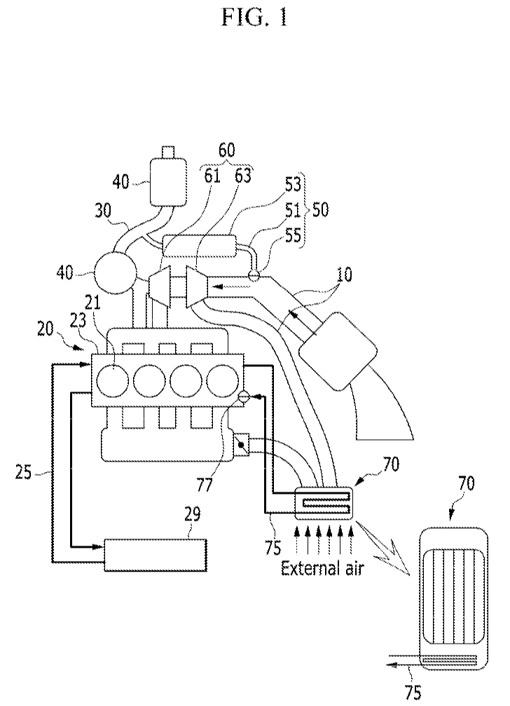

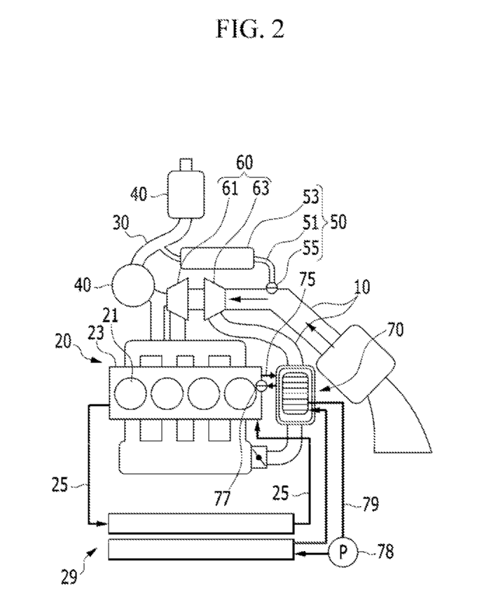

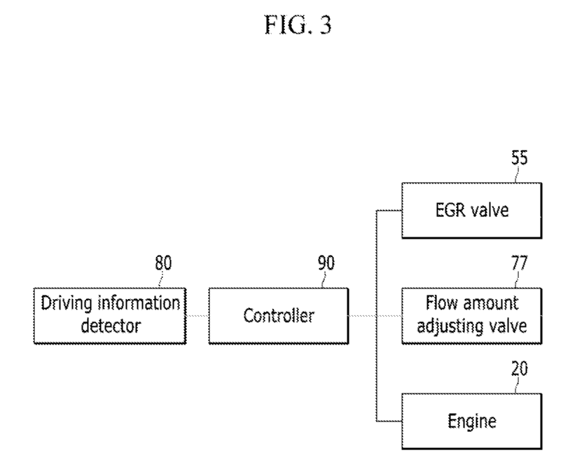

FIG. 1 is a schematic view illustrating an engine system for removing condensed water according to an embodiment of the present disclosure. FIG. 1 shows that an intercooler can be an air cooling type intercooler. FIG. 2 is a schematic view illustrating an engine system for removing condensed water according to another embodiment of the present disclosure. FIG. 2 shows that the intercooler can be a water cooling type intercooler. FIG. 3 is a block diagram illustrating an engine system for removing condensed water according to an embodiment of the present disclosure.

As shown in FIGS. 1-3, an engine system for removing condensed water according an embodiment of the present disclosure includes an engine 20, an exhaust gas recirculation (EGR) apparatus, a turbocharger 60, and an intercooler 70.

The engine 20 includes a plurality of combustion chamber 21 for generating driving torque by burning fuel. An intake line 10 for flowing intake air is provided in the engine 20, and an exhaust line 30 for flowing exhaust gas is provided in the engine 20.

An exhaust gas purification device 60 is provided in the exhaust line 4 for purifying various harmful materials included in the exhaust gas exhausted from the combustion chamber 21. The exhaust gas purification device 60 may include a lean NOx trap (LNT) for purifying nitrogen oxides, a diesel oxidation catalyst, and a diesel particulate filter.

The turbocharger 60 compresses fresh air that is inflowing through the intake line 10 and recirculation gas that is inflowing through a recirculation line to be supplied to the combustion chamber 21. The turbocharger 60 includes a turbine 61, which rotates by exhaust gas discharged from the combustion chamber 21. The turbocharger 60 also includes a compressor 63, which rotates in conjunction with the rotation of the turbine 61 and compresses fresh air and recirculation gas.

The EGR apparatus 50 recirculates some of the exhaust gas that is discharged from the combustion chamber 21 back to the combustion chamber 21. The EGR apparatus 50 may be a low-pressure exhaust gas recirculation (LP-EGR) apparatus. However, the scope of the present disclosure is not limited thereto. The EGR apparatus 50 may be a high-pressure exhaust gas recirculation (HP-EGR) apparatus.

The EGR apparatus 50 includes an EGR line 51 that is branched from the exhaust line 30 and joined to the intake line 10 of an upstream portion of the compressor 63. The EGR apparatus also includes an EGR cooler 53 disposed in the EGR line 51 and an EGR valve 55 disposed in the EGR line 51. A recirculation gas amount is adjusted by controlling opening, i.e., opening and closing, of the EGR valve 55. The opening of the EGR valve 55 is adjusted by a controller 90 that will be explained later.

The intercooler 70 increases the density of an intake air by cooling compressed air by the compressor 63 of the turbocharger 60. Thus, combustion efficiency of the engine 20 is improved. The intercooler 70 is disposed in the intake line 10 of a downstream portion of the compressor 63.

The intercooler 70 may be an air cooling type intercooler or a water cooling type intercooler.

FIG. 1 shows that the intercooler is an air cooling type intercooler. As shown in FIG. 1, an engine system according to an embodiment of the present disclosure further includes a cooling line 25 where or in which coolant for cooling the engine flows. A coolant circulation line 75 is branched from the cooling line 25. Coolant flowing in the cooling line 25 cools the engine by passing through an engine block 23 and a main radiator 29.

The coolant circulation line 75 is branched from one side of the cooling line 25 and joined to another side, i.e., the other side of the cooling line 25. The coolant circulation line 75 passes through an inside of the intercooler 70. In an embodiment, it may be preferable that the coolant circulation line 75 that passes through the inside of the intercooler 70 is disposed at a lower side of the intercooler 70.

A flow amount adjusting valve 77, which controls the coolant amount flowing in the intercooler 70, may be disposed in the coolant circulation line 75. Opening of the flow amount adjusting valve 77 may be adjusted by a controller 90. The controller 90 may be an engine control unit (ECU) provided in a vehicle.

FIG. 2 shows that the intercooler is a water cooling type intercooler. As shown in FIG. 2, an engine system according to an embodiment of the present disclosure further includes a cooling line 25 where or in which coolant flows for cooling the engine. A coolant circulation line 75 is branched from the cooling line 25. Coolant that is flowing in the cooling line 25 cools the engine by passing through an engine block 23 and a main radiator 29.

Further, an intercooler cooling line 79 is disposed in the intercooler 70. Coolant for cooling the compressed air flows in the intercooler cooling line 79. The intercooler cooling line 79 passes though the main radiator 29. In an embodiment, a water pump is disposed in the intercooler cooling line 79. Coolant flowing in the intercooler cooling line 79 is pumped by the water pump.

A flow amount adjusting valve 77, which adjusts the coolant amount circulating in the intercooler 70, may be disposed in the coolant circulation line 75. Opening, i.e., opening and closing of the flow amount adjusting valve 77 may be controlled by the controller 90. The controller 90 may be an ECU provided in a vehicle.

The engine system according to an embodiment of the present disclosure may further include a driving information detector 80 for detecting driving information including the external temperature of or around the exterior of a vehicle. The driving information detector 80 may include a temperature sensor for sensing the external temperature of the vehicle. The external temperature detected by the temperature sensor is transmitted to the controller 90.

The controller 90 may adjust the opening of the flow amount adjusting valve 77 based on the external temperature detected by the temperature sensor.

More specifically, the condensed water amount generated in the intercooler 70 is relatively small when the external temperature is higher than a predetermined temperature. Thus, the controller 90 closes the flow amount adjusting valve 77 such that the coolant does not circulate in the intercooler 70 through the coolant circulation line 75. Accordingly, it is possible to reduce the temperature in the intercooler 70 and improve cooling efficiency of the intercooler 70.

Further, the condensed water amount generated in the intercooler 70 is relatively large when the external temperature is lower than the predetermined temperature. The controller 90 opens the flow amount adjusting valve 77 such that the coolant circulates in the intercooler 70 through the coolant circulation line 75. Accordingly, the hot coolant circulates in intercooler 70 through the coolant circulation line 75. The condensed water generated in the intercooler 70 can thus be evaporated and removed.

The engine system according to an embodiment of the present disclosure may further include the driving information detector 80 detecting driving information including a water vapor amount included in recirculation gas, a water vapor amount included in fresh air inflowing through the intake line 10, and a temperature of the recirculation gas and the fresh air (the mixture or combination of which, hereinafter, is referred to as the ‘mixed gas’). The recirculation gas means exhaust gas recirculated through the EGR apparatus 50.

The controller 90 may control opening, i.e., opening and closing, of the EGR valve 55 based on the driving information detected by the driving information detector 80.

The controller 90 calculates a maximum EGR ratio at which condensed water is not generated from a saturation vapor pressure determined by the water vapor amount included in the recirculation gas, the water vapor amount included in the fresh air, and the temperature of the mixed gas supplied to the intercooler 70. The controller 90 adjusts the opening of the EGR valve 55 based on the maximum EGR ratio. The maximum EGR ratio may be represented as the recirculation gas amount/mixed gas amount.

In other words, the controller 90 calculates the maximum EGR ratio at which condensed water is not generated based on the water vapor amount included in the mixed gas and the temperature of the mixed gas supplied to the intercooler 70. The controller then adjusts opening of the EGR valve 55 based on the maximum EGR ratio.

As such, since the opening of the EGR valve 55 is adjusted based on the maximum EGR ratio, condensed water cannot be generated in the intercooler 70 and a lot of recirculation gas can be supplied to the combustion chamber 21 when the vehicle drives in a low temperature region. Accordingly, fuel consumption of the engine can be improved.

Hereinafter, an operation of the engine system according to an embodiment of the present disclosure will be described in detail.

Referring to FIGS. 1-3, exhaust gas discharged from the combustion chamber 21 is exhausted to the outside, i.e., the surrounding environment, through the exhaust line 30. A portion of the exhaust gas is not exhausted to the outside but is instead supplied to the intake line 10 through the EGR line 51 of the EGR apparatus. This portion of the exhaust gas is hereinafter referred to as the ‘recirculation gas’. The recirculation gas is mixed with external air and resupplied to the combustion chamber 21 of the engine 20.

Condensed water is generated when the high temperature and high humidity recirculation gas and the low temperature external air are mixed in the intercooler 70. The condensed water is pooled in a lower portion of the intercooler 70 by gravity. When a lot of condensed water pools in the intercooler 70 and flows into the combustion chamber 21 of the engine 20 through the intake line 10 by vibration of the vehicle, combustion stability of the engine 20 is deteriorated. Further, since the condensed water has high acidity, it is possible that the condensed water may corrode various parts of the engine.

When the external temperature is high (for example, when the external temperature is higher than a predetermined temperature), the condensed water amount generated in the intercooler 70 is small. Thus, the controller 90 inhibits the temperature of the intercooler 70 from increasing by closing the flow amount adjusting valve 77 in order to increase the cooling efficiency of the intercooler 70.

Further, since a lot of condensed water is generated in the intercooler 70 when the external temperature is low (for example, when the external temperature is lower than the predetermined temperature), removing condensed water is more important than cooling efficiency of the intercooler 70. Accordingly, the controller 90 opens the flow amount adjusting valve 77.

High temperature coolant cooling the engine 20 will then flow in the cooling line 25. When the flow amount adjusting valve 77 is opened, high temperature coolant flows in the coolant circulation line 75. Since the coolant circulation line 75 is disposed in the intercooler 70, preferably a at lower portion of the intercooler 70, condensed water pooled in the intercooler 70 is heated and evaporated by the high temperature coolant flowing in the coolant circulation line 75. Therefore, condensed water generated in the intercooler 70 can be removed.

Further, the controller 90 calculates the maximum EGR ratio at which condensed water is not generated based on the water vapor amount included in the mixed gas and the temperature of the mixed gas supplied to the intercooler 70. The controller 90 adjusts opening of the EGR valve 55 based on the maximum EGR ratio, i.e., the recirculation gas amount/mixed gas amount.

As described above, according to an embodiment of the present disclosure, it is possible to remove condensed water generated in an intercooler by circulating hot coolant in the intercooler.

Further, since the flow of high temperature coolant into the intercooler 70 can be controlled or stopped by closing the flow amount adjusting valve 77 when external temperature is high, cooling efficiency of the intercooler 70 can be improved.

Further, since opening of the EGR valve 55 is adjusted based on the maximum EGR ratio, a lot of recirculation gas can be supplied to the combustion chamber 21 of the engine 20 fuel consumption of the vehicle can be improved and NOx can be reduced.

While embodiments have been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. An engine system for removing condensed water, the engine system comprising:
an engine including a plurality of combustion chambers generating driving torque by combustion of fuel;
an intake line in which fresh air flows into the combustion chambers;
an exhaust line in which exhaust gas flows, the exhaust gas exhausted from the combustion chambers; and
an intercooler for cooling compressed air by a compressor of a turbocharger and having a coolant circulation line in which coolant flows for cooling the engine.

2. The engine system of claim 1, further comprising:
a cooling line in which the coolant flows for cooling the engine,
wherein the coolant circulation line disposed in the intercooler is branched from one side of the cooling line and joined to another side of the cooling line.

3. The engine system of claim 1, wherein the coolant circulation line is disposed at a lower portion of the intercooler.

4. The engine system of claim 1, further comprising:
a flow amount adjusting valve disposed in the coolant circulation line and adjusting a coolant amount circulating in the intercooler.

5. The engine system of claim 4, further comprising:
a temperature sensor detecting an external temperature of a vehicle; and
a controller controlling opening of the flow amount adjusting valve according to the external temperature detected by the temperature sensor.

6. The engine system of claim 5, wherein the controller closes the flow amount adjusting valve when the external temperature is higher than a predetermined temperature.

7. The engine system of claim 5, wherein the controller opens the flow amount adjusting valve when the external temperature is less than a predetermined temperature.

8. The engine system of claim 1, further comprising:
an exhaust gas recirculation apparatus including an exhaust gas recirculation (EGR) line branched from the exhaust line and joined to the intake line, and an EGR valve disposed in the EGR line;
a driving information detector detecting a driving information including a water vapor amount included in recirculation gas in the EGR line, a water vapor amount included in fresh air inflowing through the intake line, and a temperature of the recirculation gas and the fresh air; and
a controller controlling opening of the EGR valve based on the driving information detected by the driving information detector.

9. The engine system of claim 8, wherein the controller calculates a maximum EGR ratio at which condensed water is not generated from a saturation vapor pressure determined by the water vapor amount included in the recirculation gas, the water vapor amount included in the fresh air, and a temperature of the mixed gas supplied to the intercooler, and adjusts the opening of the EGR valve based on the maximum EGR ratio.

10. The engine system of claim 1, wherein the intercooler is a water cooling type intercooler.

11. The engine system of claim 1, wherein the intercooler is an air cooling type intercooler.
